(19) United States
(12) Patent Application Publication
(10) Pub. No.: US 2013/0221787 A1
(43) Pub. Date: Aug. 29, 2013

(54) SPRING ELEMENT FOR MECHANICALLY FIXING MAGNETS IN A ROTOR

(71) Applicants: Stavroula Kritharidou, Winnenden (DE); Stefan Stoermer, Sarstedt (DE); Norbert Kupke, Gilten-Nienhagen (DE); Peter Von Riegen, Barsinghausen (DE)

(72) Inventors: Stavroula Kritharidou, Winnenden (DE); Stefan Stoermer, Sarstedt (DE); Norbert Kupke, Gilten-Nienhagen (DE); Peter Von Riegen, Barsinghausen (DE)

(73) Assignee: ROBERT BOSCH GMBH, Stuttgart (DE)

(21) Appl. No.: 13/817,508

(22) PCT Filed: Aug. 16, 2011
(86) PCT No.: PCT/EP2011/064063

§ 371 Date: May 3, 2013

(30) Foreign Application Priority Data
Aug. 16, 2010 (DE) 20 2010 017 376.0

(51) Int. Cl. H02K 1/17; H02K 1/27; H02K 1/28; H02K 1/18

(52) U.S. Cl. CPC H02K 1/17; H02K 1/18; H02K 1/27; H02K 1/28
USPC 310/154.14; 310/156.16

(57) ABSTRACT

The invention relates to a rotor or stator for an electric machine, in particular a spoke rotor which is arranged concentrically about a rotational axis and comprises a permanent magnet which is arranged in a recess of the rotor or stator. A spring strand for fixing the permanent magnet in the recess is provided in the rotor or stator, said spring strand comprising a holding ring and fixing means which are arranged on the holding ring. Said holding ring is arranged concentric about the rotational axis, and the fixing means extend in the axial direction of the rotor or stator into the recess. The holding ring is annular and the fixing means lie at least partially directly on the permanent magnets. The invention also relates to an electric machine comprising the claimed rotor. The invention further relates to a hand-held machine comprising a motor having a rotor or stator of the above-mentioned type.

### BACKGROUND OF THE INVENTION

The present invention relates to a rotor or stator for an electric machine, in particular a spoked rotor, which is arranged concentrically around a rotational axis and comprises a permanent magnet which is arranged in a cutout of the rotor or stator, a spring coil being provided in the rotor or stator for fixing the permanent magnet in the cutout. Furthermore, the present invention relates to an electric machine having a rotor or stator according to the invention, and to a hand-held power tool having a motor which comprises a rotor or stator according to the invention.

In order to fasten a permanent magnet in a cutout of a rotor or stator, in particular of a synchronous machine, said permanent magnet is conventionally pressed into the cutout and is clamped by means of at least one clamping lug. The clamping lug is provided on that side of the permanent magnet which faces the rotational axis, and not only fixes the permanent magnet radially, but also secures it axially. In this technique, the permanent magnet is exposed to high mechanical loads and its surface and/or coating is frequently scratched, in particular when being pressed into the cutout and/or under operating conditions of the rotor.

In addition, both the rotor assembly and the permanent magnets expand differently over the temperature range which prevails in the rotor or stator and lies, for example, in the range from −40° to +160° C. Since the clamping lug is formed integrally with the rotor block or with disks of the rotor block, said clamping lug does not make sufficient compensation of the temperature behavior and/or the component tolerances of the permanent magnet possible, on account of the different temperature behavior and in the case of different component tolerances of the permanent magnet with respect to the disks or the rotor block.

In contrast, the German patent application with the application number DE 10 2010 039 334.7 discloses a rotor or stator for an electric machine, in which a separate elastic fixing means is arranged in the cutout, in which the permanent magnet is fitted. On account of its elasticity, the fixing means has a defined spring behavior and/or mechanical clamping behavior, with the result that it can be dimensioned in such a way that both the component tolerances of the permanent magnet and its temperature behavior can be compensated for by way of it over the spectrum of the temperatures which prevail in the rotor or stator.

### SUMMARY OF THE INVENTION

It is an object of the present invention to provide a rotor or stator, having a fixing means which is provided in the cutout of the rotor or stator and by way of which the component tolerances of the permanent magnet and its temperature behavior can be compensated for very satisfactorily, and which is improved in relation to the assembly outlay and the manufacturing costs of the fixing means and/or of the rotor or stator, and can therefore be assembled more easily and can be manufactured less expensively. It is a further object of the invention to avoid punctiform loading of the permanent magnet in a contact region between the permanent magnet and the fixing means.

The object is achieved by a rotor or stator for an electric machine, in particular by a spoked rotor, which extends in an axial direction and is arranged concentrically around a rotational axis, and which comprises a permanent magnet, which is arranged in a cutout of the rotor or stator, and comprises a spring coil for fixing the permanent magnet in the cutout, the spring coil extending in the axial direction and comprising a holding ring which is arranged concentrically around the rotational axis and at least one elastic fixing means which is arranged on the holding ring and extends into the cutout, the holding ring being of annular configuration and the elastic fixing means bearing at least partially against the permanent magnet.

The annular configuration according to the invention of the holding ring makes both very inexpensive manufacture and simple assembly of the spring coil in the rotor possible.

For this purpose, the spring coil is preferably produced from a metal, in particular from spring steel. It is particularly preferably manufactured as a stamped bent part. The spring coil is very particularly preferably produced from a material which extends flatly, in particular from a strip material. The spring coil can therefore be manufactured from a conventional material by way of conventional processes.

Since the fixing means is arranged on the holding ring, it does not have to be pushed separately into the cutout, but rather can be pushed into the cutout jointly with the holding ring by displacement of the spring coil in the axial direction. In one preferred embodiment, a plurality of permanent magnets are arranged in the rotor and a plurality of fixing means are arranged on the holding ring, the number of fixing means corresponding to the number of permanent magnets. It is also the case in this embodiment that all the fixing means can be pushed jointly with the holding ring into the cutouts of the rotor which are provided for the permanent magnets by displacement of the spring coil in the axial direction. As a result, the assembly of the spring coil can be carried out very quickly and simply.

The spring coil can preferably be fitted releasably into the rotor or stator. It is particularly preferably fitted after the fitting of the permanent magnet into the cutout. This has the advantage that the permanent magnet can be fitted without force into the cutout, in particular before the assembly of the spring coil. In the context of the invention, “without force” means that the permanent magnet is not clamped in or pressed in, but rather it is introduced, in particular pushed in or inserted, in such a way that, in the process, it, in particular its surface and/or a coating of the permanent magnet, is virtually not loaded mechanically or is not loaded mechanically. The permanent magnet is therefore not damaged during the fitting of the permanent magnet into the cutout. Since the permanent magnet is fitted into the cutout before the assembly of the spring coil, it is first clamped into the cutout by the arrangement of the fixing means.

According to the invention, the fixing means bears at least partially against the permanent magnet. Therefore, no spacer elements are provided on the rotor or stator, which spacer elements space the fixing means apart from the permanent magnet and protect the latter as a result from damage, in particular from being scratched. The fixing of the permanent magnet therefore requires merely the spring coil, with the result that the costs for manufacturing the rotor are also low on account of the low number of components.

It is preferred to adapt the geometric shape of the spring coil, in particular of the fixing means, in such a way that the permanent magnet is not damaged by the spring coil, either during the assembly of the rotor or in the operating state. For this purpose, the fixing means is preferably rounded on the side which faces the permanent magnet, with the result that a contact region, in which the permanent magnet bears against the fixing means, between the permanent magnet and the fixing means is as small as possible and the permanent magnet also cannot be damaged, for example by an edge, in the event of a displacement of the fixing means. In addition, it is preferred to coat the spring coil, in particular the fixing means, with the result that it has no burrs.

The fixing means is of elastic configuration. It can preferably be deformed counter to a restoring force and therefore has a defined spring behavior and/or mechanical clamping behavior. As a result, it can be dimensioned in such a way that both the component tolerances of the permanent magnet and its temperature behavior can be compensated for by way of the fixing means over the spectrum of the temperatures which prevail in the rotor or stator. In one preferred embodiment, the fixing element is of elastic and plastic configuration, with the result that it still has sufficient elasticity after a plastic deformation, in particular during clamping of the permanent magnet, in order to compensate for component tolerances and/or the temperature behavior of the permanent magnet.

It is preferred that the fixing means fixes the permanent magnet in the cutout in the radial direction, that is to say in a direction which emanates radially from the rotational axis. As a result, the permanent magnet is arranged substantially without play in the cutout on the side which lies opposite the fixing means.

In one preferred embodiment, the fixing means acts additionally in the axial direction. Here, the elasticity of the fixing means is designed in such a way that the permanent magnet is clamped in the cutout. It is preferably no longer axially displaceable as a result. However, it is likewise preferred that the fixing of the permanent magnet in the axial direction takes place by means of an additional axial fixing means, with the result that the axial fixing is independent of the radial fixing and the component tolerances and the temperature behavior can be compensated for differently in the axial direction and in the radial direction.

The spring coil bears at least partially against the rotor or stator. For this purpose, the rotor or stator preferably has a bearing face which extends in the axial direction and delimits the cutout at least partially. It is preferred that the spring coil has at least one corresponding bearing face, by way of which it is supported on the bearing face. In one preferred embodiment, the bearing face is configured in such a way that at least the fixing means, and possibly additionally the holding ring, is/are supported on the bearing face. The holding ring and/or the fixing means are/is particularly preferably arranged on the bearing face without play. In addition, the fixing means is preferably also rounded on the side which faces away from the permanent magnet, with the result that it does not damage the bearing face in the case of a displacement.

Since the holding ring of the spring coil is of annular configuration, the fixing means, possibly also the holding ring, can be pushed onto the bearing face in the axial direction, in particular without play. Here, the fixing means is arranged in the cutout.

Furthermore, the fixing means preferably has a deforming means, it being possible for at least the deforming means of the fixing means to be deformed elastically.

It is preferred that the deforming means is spaced apart from the bearing face in the contact region. Furthermore, the deforming means is preferably bent into the cutout both from the contact region counter to the radial direction and from the corresponding bearing face in the radial direction. The deforming means preferably has a rising or falling flank between the contact region and the corresponding bearing face. It is particularly preferable that the deforming means extends in an undulating manner into the cutout in the axial direction.

As a result, the deforming means is bent or rounded in the axial direction on its side which faces the permanent magnet and optionally additionally on its side which faces away from the permanent magnet, in such a way that it does not damage, and in particular does not scratch, the permanent magnet and/or the bearing face in the event of a displacement, in particular in the axial direction.

It is preferred that the deforming means has a wavelength, an amplitude height and/or a material thickness. The deforming means particularly preferably has the restoring force and therefore acts as a spring. In one preferred embodiment, the deforming means is of approximately sinusoidal configuration.

The wavelength, amplitude height and/or the material thickness of the deforming means fix/fixes the shape and properties of the deforming means, in particular its deformability, strength and/or deformation direction. Said properties define the spring stiffness of the deforming means. A deforming means of a low material thickness can be deformed by the application of less energy, for example, in comparison with a deforming means of greater material thickness with the same wavelength and amplitude. The spring stiffness of the deforming means of lower material thickness is therefore smaller in comparison with the spring stiffness of the deforming means of greater material thickness, with the same amplitude and wavelength. By way of adaptation of the shape and the properties of the deforming means, the deforming means can be designed in such a way that the component tolerances which occur in the rotor or stator and temperature influences over their entire spectrum are covered and very satisfactory compensation is possible.

The fixing means particularly preferably has a plurality of deforming means. Here, in one preferred embodiment, the wavelength, amplitude height and/or material thickness of the deforming means are/is identical, with the result that the fixing means can be manufactured very simply. In one likewise preferred embodiment, the wavelength, amplitude height and/or material thickness are/is different. As a result, the energy which is to be introduced into the deforming means for deformation is different, with the result that the deformation of the deforming means can be triggered in a targeted manner, in particular one after another.

In one preferred embodiment which likewise achieves the object, the rotor or stator has a bearing face for the fixing means, which bearing face delimits the cutout on its side which faces the rotational axis, the bearing face being of planar configuration. The bearing face preferably delimits the cutout in a radial direction. It is particularly preferred that it is defined by an axial line which extends in the axial direction and by a chord line which extends in the direction of a chord of a circle which is arranged concentrically around the rotational axis. As a result, the bearing face is of planar configuration and preferably extends parallel to the permanent magnet. The corresponding bearing face of the spring coil is likewise preferably of planar configuration, with the result that the spring coil is supported on the bearing face over as large an area as possible.

However, a bearing face is likewise preferred which is defined by the axial line which extends in the axial direction and by a circular line which extends circularly and concentrically around the rotational axis. In this embodiment, it is preferred that the spring coil, in particular the holding ring and the fixing means, is also arranged circularly and concentrically around the rotational axis at least in the region of the corresponding bearing face. As a result, the spring coil can also be supported on the bearing face over as large an area as possible in this embodiment.

At least in the contact region, the deforming means preferably has a width which corresponds to a contact width of the permanent magnet. Contact width is understood to mean the width of the permanent magnet, minus its possibly rounded corners. In the region of the corresponding bearing face, it likewise preferably has a width which corresponds to a width of the bearing face. Since the deforming means in the contact region and the permanent magnet, and the deforming means in the region of the corresponding bearing face and the corresponding bearing face, have the same width or contact width, their edges lie approximately above one another in the stated regions in the assembled state. As a result, the edges of the deforming means cannot damage the permanent magnet or the bearing face in the case of a displacement, and no formation of score marks occurs in the contact region and/or on the bearing face.

The permanent magnet is preferably arranged in a spoke-shaped manner in the rotor or stator. It is preferably configured as a flat magnet. In one preferred embodiment, the rotor or stator comprises a multiplicity of permanent magnets, in each case one fixing means being provided for each permanent magnet on the holding ring. The permanent magnets and the fixing means are preferably arranged distributed uniformly in the circumferential direction. Furthermore, it is preferred that the rotor or stator is produced as a disk assembly from a multiplicity of disks.

In the rotor or stator according to the invention, the radial fixing and additionally, depending on the design of the fixing means, also the axial fixing of the permanent magnet in the cutout by way of the spring coil are ensured very inexpensively. The spring coil is preferably manufactured by way of conventional processes as a stamped bent part from a flat strip material, in particular from a metal sheet. It makes compensation of component tolerances and temperature changes possible in the radial direction. Moreover, the permanent magnet is mechanically loaded less in every operating state of the rotor or stator in comparison with conventional fastening of the permanent magnet in the cutout by means of clamping lugs.

Furthermore, the object is achieved by way of a motor, in particular a synchronous machine, which comprises a rotor or stator according to the invention. Furthermore, the object is achieved by way of a hand-held power tool having a motor which comprises a rotor or stator according to the invention. A hand-held power tool of this type is, for example, a drilling machine, a jigsaw or the like.

### BRIEF DESCRIPTION OF DRAWINGS

In the following text, the invention will be described using figures. The figures are merely of exemplary nature and do not restrict the general concept of the invention.

In the drawings:

FIG. 1(a) shows a first embodiment of a spring coil for a rotor according to the invention in a perspective view,

FIG. 1(b) shows a section through the spring coil of FIG. 1(a),

FIG. 1(c) shows a section through a holding ring of the spring coil of FIG. 1(a),

FIG. 1(d) shows a rotor according to the invention with the spring coil of FIG. 1(a) in a perspective view,

FIG. 1(e) shows a detail of the rotor of FIG. 1(d) in a sectional illustration, not all of the permanent magnets being shown in the detail,

FIG. 2 shows a section through a further embodiment of a rotor according to the invention with a further embodiment of a spring coil, and

FIG. 3 diagrammatically shows a contour of an undulating region of a rotor according to the invention.

### DETAILED DESCRIPTION

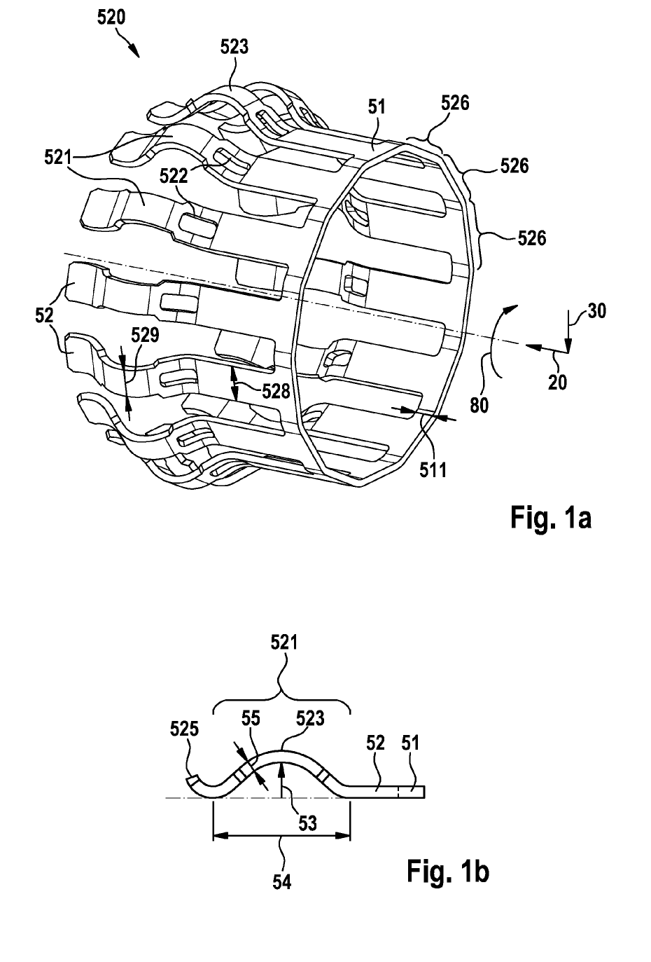

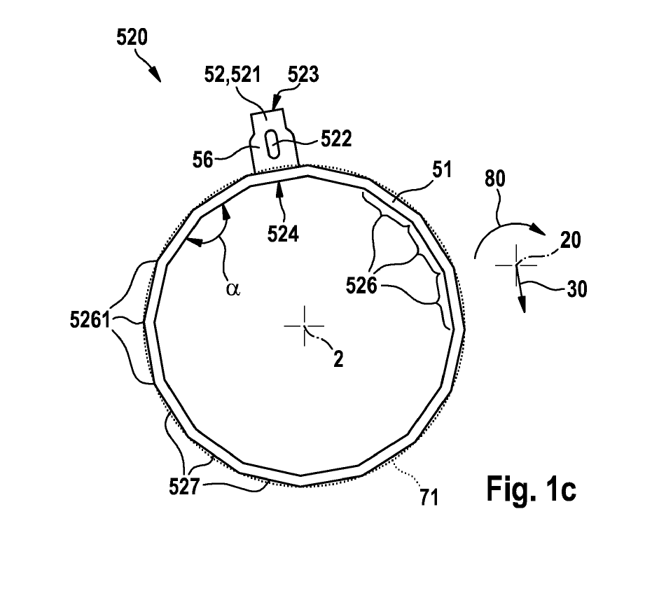

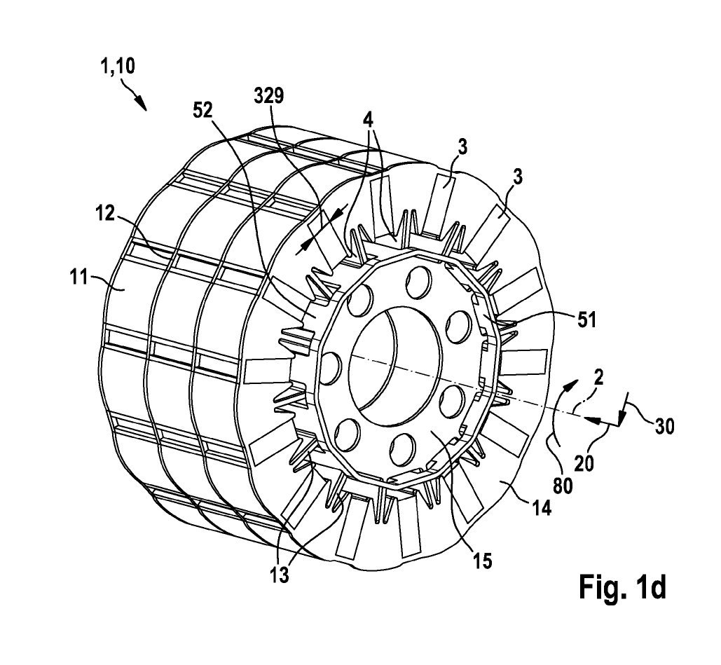

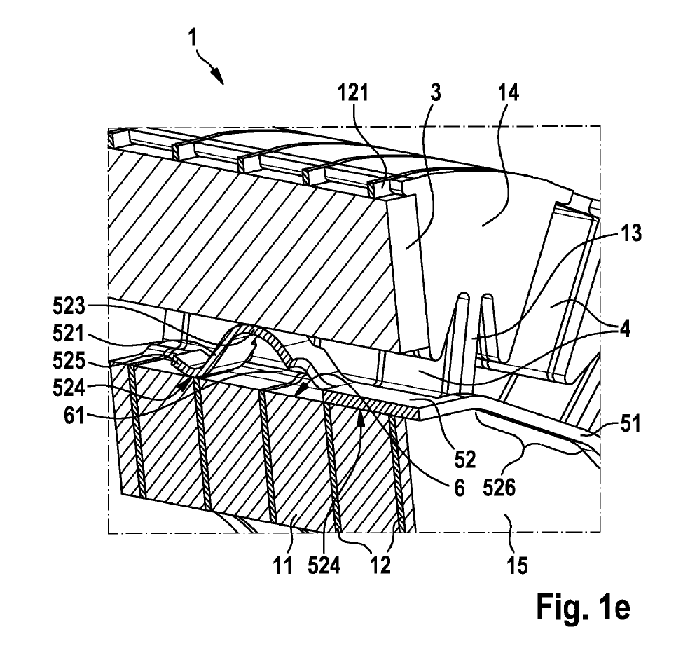

FIG. 1 shows a first embodiment of a spring coil 520 for a rotor 1 according to the invention in a perspective view. The spring coil 520 which is shown is produced as a stamped bent part from a metal sheet comprising spring steel. It has a holding ring 51 which is of annular configuration. The holding ring 51 extends concentrically around a rotational axis 2. In addition, it has a width 511 in an axial direction 20, by way of which width 511 it is given a rigidity and strength, with the result that, in particular, it does not tear under loading.

A multiplicity of fixing means 52 which extend in each case in the axial direction 20 are arranged in a comb-like manner on the holding ring 51. The fixing means 52 are arranged and spaced apart from one another on the holding ring 51 such that they are distributed uniformly in a circumferential direction 80. They in each case have a deforming means 521 which can be deformed elastically. Here, the deforming means 521 are in each case of undulating configuration and have a wavelength 54, an amplitude height 53 and a material thickness 5520 which define the shape and properties of the deforming means 521. In addition, they have a spring stiffness and a restoring force and act like a spring.

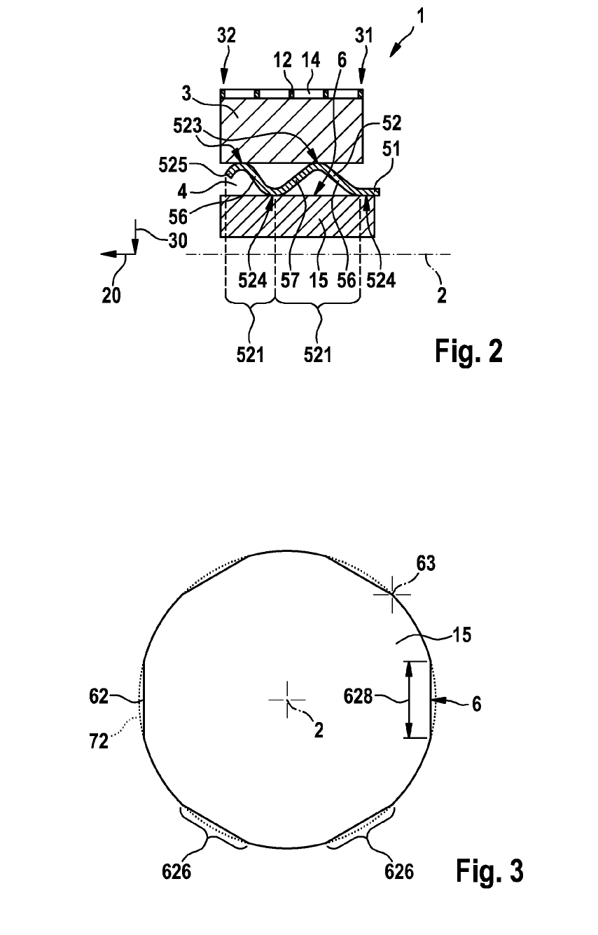

Furthermore, the fixing means 52 which act here as springs can be dimensioned by way of changed shapes and properties of the deforming means 521 in such a way that they fix the permanent magnet 3 in each case in the radial direction 30, and preferably additionally also in the axial direction 20, by clamping it in the cutout 4. Here, the permanent magnet 3 is pressed radially to the outside against transverse webs 121 of the rotor 1. Or they can be dimensioned in such a way that, in order to fix the permanent magnet 3, either one fixing means 52 at a first or second end 31, 32 (see FIG. 2) of the permanent magnet 3 is sufficient, or a fixing means 52 has to be provided at both ends 31, 32.

The fixing means 52 are produced in one piece with the holding ring 51. In principle, however, multiple-piece production is also possible. Since the fixing means 52 are connected to one another by the holding ring 51, assembly of all the fixing means 52 is possible in a single work step.

Between the fixing means 52, the holding ring 51 in each case has a kink 5261 with an angle α, with the result that, in cross section (see FIG. 1c), it has a contour which is formed by equally long chord lines 527, which adjoin one another, of a first virtual circle 71 which is arranged concentrically around the rotational axis 2. Here, the first virtual circle 71 is shown by way of example on the outer circumference of the holding ring 51. As a result, the spring coil 520 has a number of identical segments 526. Each fixing means 52 is provided for fixing in each case one permanent magnet 3 in the rotor 1. Since each segment 524 comprises a fixing means 52 here, each segment 526 is assigned to in each case one permanent magnet 3 of the rotor 1. In this embodiment, the concentric shape of the holding ring 51 can be manufactured from a flat metal sheet by simple bending of the metal sheet in the kinks 5261 in each case by the angle α.

In this embodiment, a shape of the spring coil 520 which is arranged concentrically around the rotational axis 2 can be manufactured from a flatly extending metal sheet or strip material, by the spring coil 520 being stamped from the metal sheet or strip material, and by the holding ring 51, after the introduction of the deforming means 521 into the fixing means 52, being bent in each case between the fixing means 52. Manufacturing of this type is possible very inexpensively by way of conventional processes. Subsequently, the open ends of the holding ring 51 are then connected to one another, in particular welded.

In order to fix the permanent magnets 3 of the rotor 1, the spring coil 520, in particular after the fitting of the permanent magnets 3 into the cutouts 4 of the rotor 1, can be pushed onto bearing faces 6 of the rotor 1 by displacement in the axial direction 20, with the result that the fixing means 52 extend in the axial direction 20 and into the cutouts 4. The bearing faces 6 delimit the cutouts 4, in which the permanent magnets 3 are arranged, in each case on their sides which face the rotational axis 2.

The fixing means 52 fix the permanent magnets 3 in each case at least in the radial direction 30. In FIGS. 1a and d, a radial direction 30 is shown in each case by way of example by an arrow. In the assembled state (see FIGS. 1d, e), the spring coil 520 is arranged on that side of the permanent magnet 3 in the rotor 1 which faces the rotational axis 2.

FIG. 1d shows by way of example a rotor 1 according to the invention with the spring coil 520 of FIGS. 1a, b and c. FIG. 1c diagrammatically shows a section through a holding ring 51, only a single fixing means 52 which is arranged on the holding ring 51 being shown here by way of example, for the sake of clarity. FIG. 1e shows a detail from the rotor 1 of FIG. 1d. In the sectional illustration of FIG. 1e, not all the permanent magnets 3 which are to be arranged in the rotor 1 are shown for the sake of clarity.

The rotor 1 is produced as a disk assembly 10 comprising a multiplicity of disks 11, 12. Each of the disks 11, 12 has a number of cutouts 4 which corresponds to the number of permanent magnets 3, into which cutouts 4 the permanent magnets 3 are fitted in each case. Here, the permanent magnets 3 are provided in the rotor 1 in a spoke-like manner.

On that side of the permanent magnets 3 which faces away from the rotational axis 2, said permanent magnets 3 are secured against displacement counter to the radial direction 30 by transverse webs 121 which are provided at least on some of the disks 12.

The spring coil 520 has at least one corresponding bearing face 524, by way of which it bears against the bearing face 6 and is supported on the latter. The corresponding bearing face 524 is provided on the fixing means 52 and/or on the holding ring 51.

It is preferred that the spring coil 520 is supported on the bearing face 6 by way of its corresponding bearing face 524 and over as large an area as possible. For this purpose, the bearing faces 6 are defined in each case by an axial line 63 which extends in the axial direction 20 and by a chord line 62 of a second virtual circle 72 which is arranged concentrically around the rotational axis 2 (see FIG. 3), with the result that they are likewise of planar configuration, analogously with respect to the segments 526 of the spring coil 520.

The fixing means 52 are spaced apart from the bearing face 6 in a contact region 523, in which they bear against the permanent magnets 3. In order not to damage the permanent magnets 3 during the pushing of the fixing means 52 into the cutouts 4 and under operating conditions, the fixing means 52 are rounded on their side which faces the permanent magnet 3. As a result, the contact region 523 with the permanent magnet 3 runs here approximately linearly in the circumferential direction 80 and is as small as possible.

Moreover, it has no burrs as a result of its rounded shape in the contact region 523.

In addition, the fixing means 52 is also rounded on its side which faces away from the permanent magnet 3. For this purpose, the deforming means 521 is bent into the cutout 4 both from the contact region 523 counter to the radial direction 30 and from the corresponding bearing face 524 in the radial direction 30. As a result, the fixing means 52 has a rising flank 56 and a falling flank 57 between the contact region 523 and the corresponding bearing face 524, with the result that the deforming means 521 of the fixing means 52 are of undulating configuration here.

The fixing means 52 in each case have an open end 525 which is likewise bent into the cutout 4, with the result that it does not impede a displacement of the fixing means 52 in or counter to the axial direction 20.

Moreover, the fixing means 52 is preferably produced from a material which is softer than the material, from which the permanent magnet 3 is produced, since it bears directly against the permanent magnet 3, and/or the fixing means 52 is additionally coated with a material of this type. This also prevents the permanent magnet 3 from being damaged by the fixing means 52.

Here, in each case cutouts 522 (see FIG. 1c) are provided on the rising flank 56 in the form of holes which firstly reduce the spring stiffness of the deforming means 521 in the region of the rising flank 56 and are additionally provided for a fitting tool (not shown), by way of which the spring coil 520 can be assembled in the rotor 1.

It is preferred to provide a spring coil 520 at one end 31, 32 of the permanent magnet 3. In this embodiment, it is preferred, furthermore, that the fixing means 52 has a deforming means 521, the contact region 523 of which is arranged approximately in the middle of the permanent magnet 3. The fixing means 52 likewise preferably has at least two deforming means 521 which are arranged approximately symmetrically with respect to a center line (not shown) through the permanent magnet 3, with the result that the permanent magnet 3 rests on two contact regions 523. Here, the center line divides the permanent magnet 3 in the axial direction 20. In a further preferred embodiment, in each case one spring coil 520 is provided on both sides of the permanent magnet 3, which spring coils 520 in each case have a deforming means 521. In this embodiment, the deforming means 521 are preferably likewise arranged symmetrically with respect to the center line through the permanent magnet 3.

Starting from the bearing faces 6, in the following text that part of the rotor 1 which faces the rotational axis 2 is called shaft region 15 and that part of the rotor 1 which faces away from the rotational axis 2 is called magnet region 14. In the magnet region 14, the permanent magnets 3 are fitted into the rotor 1 in the assembled state. A shaft (not shown) is provided in the shaft region 15 in the assembled state.

Between the cutouts 4, the disks 11, 12 of the rotor 1 in each case have longitudinal webs 13 which connect the magnet region 14 of the rotor 1 to the shaft region 15 of the rotor 1. In addition, the cutouts 4 of the rotor 1 which is shown here in each case have guide means 61 (see FIG. 1e) which extend in the axial direction 20 and are configured as webs. In the region of the corresponding bearing face 524, the fixing means 52 has a width 528 which corresponds to a width 628 (see FIG. 3) of the bearing face 6. During the displacement of the spring coil 520, the fixing means 52 are guided as a result along the guide means 61, with the result that they can be pushed into the cutout 4 into a defined position and their assembly is simple. On account of the guide means 61 which are configured as webs, the bearing face 6 of the rotor 1 is formed here by a groove.

In the contact region 523, the width 529 of the deforming means 521 corresponds to the contact width 329 of the permanent magnet 3. As a result, the deforming means 521 bears against the permanent magnet 3 approximately without an offset, and scratching or a formation of score marks does not occur on the permanent magnet 3 in the case of a displacement of the spring coil 520 in the cutout 4, for example, during the assembly or under operating conditions.

In the exemplary embodiment which is shown in FIGS. 1d and e, the shaft region 15 of the rotor 1 is configured in such a way that in each case only the fixing means 52 bear against the bearing faces 6.

FIG. 2 diagrammatically shows a detail of a further embodiment of a rotor 1 according to the invention in a sectional illustration. The rotor 1 is arranged concentrically around a rotational axis 2. It has the cutout 4, in which the permanent magnet 3 is arranged. The permanent magnet 3 is configured as a flat magnet, is arranged in the rotor 1 in a spoke-like manner, and it extends in the axial direction of the rotor 1. The axial direction 20 and, by way of example, a radial direction 30 are shown by arrows.

The permanent magnet has the first end 31 and the second end 32 and can be fixed by means of the spring coil 520. For this purpose, the spring coil 520 has a fixing means 52, by way of which the permanent magnet 3 is fixed at least radially, and which extends in the cutout 4 and in the axial direction 20.

In contrast to the embodiment of FIG. 1, however, the shaft region 15 of said rotor 1 is provided in such a way that the holding ring 51 also bears at least partially against the bearing face 6. For this purpose, the shaft region 15, as is shown in FIG. 2 in a larger than life representation, is provided here such that it is extended with respect to the magnet region 14. An embodiment is also conceivable, in which the longitudinal web 13 between two adjacent cutouts 4 is shortened in the axial direction 20, with the result that the holding ring 51 is arranged between the magnet region 14 and the shaft region 15 in the assembled state.

The fixing means 52 differs from the fixing means 52 of FIG. 1 additionally in that it has a second deforming means 521. Here, however, the open end 525 of the second deforming means 521 is provided in the region of the falling flank 57 of the second deforming means 521, with the result that the length of the second deforming means 521 is shorter than its wavelength 54.

FIG. 3 diagrammatically shows a contour of a shaft region 15 of a further embodiment of a rotor 1 according to the invention. For reasons of clarity, the rotor 1 which is shown here has merely six bearing faces 6 which are defined by the axial line 63 and chord lines 62. In addition, the longitudinal webs 13 and guide means 61 which can also be provided optionally are not shown.

In contrast to the contour of the rotors 1 of the embodiments of FIGS. 1 and 2, the contour of said rotor 1 is of circular configuration between the bearing faces 6. A spring coil 520 for said rotor 1 preferably has a shape which corresponds thereto. Although it therefore has the planar corresponding bearing face 524 of the holding ring 51 and/or fixing means 52, its holding ring 51 is preferably of circular configuration analogously to the configuration of the rotor 1 between the corresponding bearing faces 524.

A rotor 1 according to the invention has the advantage that fixing of the permanent magnet 3 in the cutout 4 makes a very satisfactory compensation of component tolerances and temperature behavior of the components possible. Furthermore, the permanent magnet 3 can be fitted into the cutout 4 without force. As a result, it, in particular its coating, for example from epoxy or Ni—Cu—Ni, is not damaged during the insertion. Furthermore, the spring coil 520 is, in particular the fixing means 52 are, formed in such a way that the permanent magnets 3 are also not damaged by the fixing means 52 under operating conditions. In addition, the spring coils 520 can be manufactured very inexpensively as stamped bent parts from conventional material by way of conventional processes.

The fastening which is shown of the permanent magnet 3 in a rotor 1 according to the invention is also possible in an analogous way in a stator (not shown).

1. A rotor (1) or stator for an electric machine, which extends in an axial direction (20) and is arranged concentrically around a rotational axis (2), and which comprises a permanent magnet (3), which is arranged in a cutout (4) of the rotor (1) or stator, and a spring coil (520) for fixing the permanent magnet (3) in the cutout (4), the spring coil (520) comprising a holding ring (51) which is arranged concentrically around the rotational axis (2) and at least one elastic fixing means (52) which is arranged on the holding ring (51) and extends into the cutout (4) in the axial direction (20), characterized in that the holding ring (520) is of annular configuration and the elastic fixing means (52) bears at least partially against the permanent magnet (3).

2. The rotor (1) or stator as claimed in claim 1, characterized in that the spring coil (520) is produced from a metal.

3. The rotor (1) or stator as claimed in claim 1, characterized in that the fixing means (52) is produced as a stamped bent part.

4. The rotor (1) or stator as claimed in claim 1, characterized in that the rotor (1) or stator has a multiplicity of permanent magnets (3), in each case one elastic fixing means (52) being provided for each permanent magnet (3) on the spring coil (520).

5. The rotor (1) or stator as claimed in claim 1, characterized in that the holding ring (51) and/or the fixing means (52) have/has a corresponding bearing face (524), by way of which the spring coil (520) is supported by a bearing face (6) of the rotor (1) or stator.

6. The rotor (1) or stator as claimed in claim 1, characterized in that the fixing means (52) fixes the permanent magnet (3) in the cutout (4) in the a radial direction (30).

7. The rotor (1) or stator as claimed in claim 1, characterized in that the fixing means (52) has a deforming means (521), at least the deforming means (521) being of elastic configuration.

8. The rotor (1) or stator as claimed in claim 7, characterized in that the deforming means (521) is spaced apart from the bearing face (6) in a contact region (523), in which said deforming means (521) bears against the permanent magnet (3).

9. The rotor (1) or stator as claimed in claim 7, characterized in that the deforming means (521) is of undulating configuration, and has a wavelength (54), an amplitude height (53) and a material thickness (55).

10. A rotor (1) or stator, as claimed in claim 1, which extends in an axial direction (20) and is arranged concentrically around a rotational axis (2), and which comprises a permanent magnet (3), which is arranged in a cutout (4) of the rotor (1) or stator, and a fixing means (52) for fixing the permanent magnet (3) in the cutout (4), the fixing means (52) extending into the cutout (4) in the axial direction (20), the cutout (4) having a bearing face (6) for the fixing means (52), which bearing face (6) delimits the cutout (4) on its side which faces the rotational axis (2), characterized in that the bearing face (6) is of planar configuration.

11. The rotor or stator as claimed in claim 10, characterized in that a corresponding bearing face (524) of the spring coil (520) is of planar configuration.

12. The rotor (1) or stator as claimed in claim 7, characterized in that the deforming means (521) is rounded at least in the contact region (523) on the side which faces the permanent magnet (3), and/or is bent into the cutout (4).

13. The rotor (1) or stator as claimed in claim 1, characterized in that the holding ring (51) and/or the fixing means (52) are/is rounded at least on the corresponding bearing face (524) on the side which faces away from the permanent magnet (3), and/or are/is bent into the cutout (4).

14. The rotor (1) or stator as claimed in claim 7, characterized in that the deforming means (521) is configured as a spring.

15. The rotor (1) or stator as claimed in claim 1, characterized in that a width (529) of the fixing means (52) in the contact region (523) corresponds to a contact width (329) of the permanent magnet (3), and a width (528) of the fixing means (52) in the region of the corresponding bearing face (524) corresponds to a width (628) of the bearing face (6), and is identical, in particular.

16. A motor, having a rotor (1) or stator as claimed in claim 1.

17. The rotor or stator of claim 1 wherein a width (529) of the fixing means (52) in the contact region (523) corresponds to a contact width (329) of the permanent magnet (3), and a width (528) of the fixing means (52) in the region of the corresponding bearing face (524) corresponds to a width (628) of the bearing face (6), and is identical.

18. The rotor (1) or stator as claimed in claim 1, characterized in that the spring coil (520) is produced from a spring steel.

19. The rotor (1) or stator as claimed in claim 1, wherein the rotor or stator is a spoked rotor.

20. A rotor (1) or stator, which extends in an axial direction (20) and is arranged concentrically around a rotational axis (2), and which comprises a permanent magnet (3), which is arranged in a cutout (4) of the rotor (1) or stator, and a fixing means (52) for fixing the permanent magnet (3) in the cutout (4), the fixing means (52) extending into the cutout (4) in the axial direction (20), the cutout (4) having a bearing face (6) for the fixing means (52), which bearing face (6) delimits the cutout (4) on its side which faces the rotational axis (2), characterized in that the bearing face (6) is of planar configuration.
